(19) United States
(12) Patent Application Publication
(10) Pub. No.: US 2016/0171573 A1
(43) Pub. Date: Jun. 16, 2016

(54) Method and a Device Thereof for Online Merchandise Anti-counterfeiting Verification

(71) Applicant: Xinyu Xingbang Information Industry Co., Ltd, Xinyu (CN)

(72) Inventors: Xiaohong Yao, Foshan (CN); Zhihong Zhou, Shaoyang (CN)

(73) Assignee: Xinyu Xingbang Information Industry Co., Ltd

(21) Appl. No.: 14/729,036

(22) Filed: Jun. 2, 2015

(30) Foreign Application Priority Data
Dec. 16, 2014 (CN) 201410787513.1

(51) Int. Cl. G06Q 30/06

(52) U.S. Cl. CPC G06Q 30/0609

(57) ABSTRACT

The invention discloses a method and a device thereof for online merchandise anti-counterfeiting verification; the method comprises: judging whether a merchant meets the official qualification, if so, entering the merchandise information and verifying the merchandise is authentic by virtue of calling an official verification interface; otherwise, judging whether the merchandise is a brand merchandise; otherwise, confirming the merchandise is non-authentic; judging whether the merchandise has a scraping anti-counterfeiting area, if so, adding an authentication identification otherwise, judging whether the manufacturer has an anti-counterfeiting system, if so, executing the next step; otherwise, acquiring and storing the merchandise production information by virtue of calling a manufacturer verification interface, and comparing and verifying the entered merchandise information; verifying the merchandise by virtue of calling the manufacturer verification interface. The invention has the following beneficial effects: the number of query times for anti-counterfeiting is not limited, and the plural anti-counterfeiting queries are allowed.

### CROSS-REFERENCE TO RELATED APPLICATIONS

The present application claims the benefit of Chinese Patent Application No. 201410787513.1 filed on Dec. 16, 2014, the entire content of which is hereby incorporated by reference.

### FIELD OF THE INVENTION

The invention relates to the field of merchandise anti-counterfeiting, and in particular relates to a method and a device thereof for online merchandise anti-counterfeiting verification.

### BACKGROUND OF THE INVENTION

With the wide application of the internet, the online shopping has become a way for people to buy merchandises, which brings about convenience for the life of people. By way of the online shopping, people can buy the favorite merchandises via the internet without leaving the home. At present, the c2c and b2b malls are basically in lack of an online merchandise anti-counterfeiting query function, and the existing online merchandise is queried through scraping the anti-counterfeiting verification area; therefore, the number of query times is limited and the query becomes invalid after one time, and the anti-counterfeiting query doesn't support plural operations.

### SUMMARY OF THE INVENTION

In order to solve the technical problems of the prior art that the number of query times for anti-counterfeiting is limited and the anti-counterfeiting query doesn't support plural operations, the invention provides a method and a device thereof for online merchandise anti-counterfeiting verification that the number of query times for anti-counterfeiting is not limited and the anti-counterfeiting query supports plural operations.

The technical scheme of the invention to solve the technical problems is as follows: construct an online merchandise anti-counterfeiting verification method, which comprises the following steps:

A) Applying for opening a store by a merchant;

B) Judging whether the merchant meets the official qualification, if so, confirming the merchant as an official merchant and executing step

C), otherwise, confirming the merchant as a common merchant and executing step D);

C) Entering the merchandise information by the official merchant, verifying the entered merchandise is authentic by virtue of calling an official verification interface and executing step I);

D) Entering the merchandise information of the common merchant and judging whether the entered merchandise by the common merchant is a brand merchandise, if so, executing step E); otherwise, confirming the merchandise is non-authentic and executing step I);

E) Judging whether the brand merchandise has a scraping anti-counterfeiting area, if so, adding an authentication identification to the brand merchandise and prompting to authenticate the merchandise by scraping the scraping anti-counterfeiting area, and executing step I); otherwise, executing step F);

F) Judging whether the manufacturer of the brand merchandise has an anti-counterfeiting system, if so, executing step G); otherwise, executing step H);

G) Directly verifying the brand merchandise by virtue of calling a brand manufacturer verification interface, and executing step I);

H) Acquiring and storing the production information of the brand merchandise by virtue of calling the brand manufacturer verification interface, comparing and verifying the merchandise production information with the entered merchandise information, and executing step I).

According to the method for online merchandise anti-counterfeiting verification, the step C) further comprises:

C1) Entering the merchandise information by the official merchant;

C2) Generating a verification code by virtue of calling the official verification interface, recording the entered merchandise in the database to be authentic and recording the verification code;

C3) Adding an authentication identification to the entered merchandise.

According to the method for online merchandise anti-counterfeiting verification, the step G) further comprises:

G1) Judging whether the brand merchandise is authentic by virtue of calling a brand manufacturer verification interface, if so, adding an authentication identification to the brand merchandise, otherwise, executing step G2);

G2) Confirming the brand merchandise as a fake merchandise, and undergoing a fake merchandise handling process.

According to the method for online merchandise anti-counterfeiting verification, the step H) further comprises:

H1) Acquiring the production information of the merchandise by virtue of calling the brand manufacturer verification interface;

H2) Storing the production information of the merchandise in the database;

H3) Comparing the information of the entered brand merchandise with the production information of the merchandise saved in the database, judging whether the entered information is matched with the saved production information, if so, adding an authentication identification to the brand merchandise, otherwise, confirming the brand merchandise as a fake merchandise, and undergoing a fake merchandise handling process.

According to the method for online merchandise anti-counterfeiting verification, the brand manufacturer verification interface acquires the production information of the merchandise from the merchandise generating system of the brand manufacturer.

The invention further relates to a device for implementing the method for online merchandise anti-counterfeiting verification, which comprises:

An applying unit: for applying for opening a store by a merchant;

A qualification judging unit: for judging whether the merchant meets the official qualification, if so, confirming the merchant as an official merchant, otherwise, confirming the merchant as a common merchant;

An entering and calling unit: for entering the merchandise information by the official merchant, verifying the entered merchandise is authentic by virtue of calling the official verification interface;

A brand judging unit: for entering the merchandise information by the common merchant and judging whether the entered merchandise by the common merchant is a brand merchandise, if so, further judging whether the brand merchandise has a scraping anti-counterfeiting area, otherwise, confirming the merchandise is non-authentic;

An anti-counterfeiting area judging unit: for judging whether the brand merchandise has a scraping anti-counterfeiting area, if so, adding an authentication identification to the brand merchandise and prompting to authenticate the merchandise by scraping the scraping anti-counterfeiting area;

An anti-counterfeiting system judging unit: for judging whether the manufacturer of the brand merchandise has an anti-counterfeiting system;

A calling and verifying unit: for directly verifying the brand merchandise by virtue of calling the brand manufacturer verification interface;

A calling and storing unit: for acquiring and storing the production information of the brand merchandise by virtue of calling the brand manufacturer verification interface, comparing and verifying the merchandise production information with the entered merchandise information;

A verification completing unit: for completing the verification.

According to the device for implementing the method for online merchandise anti-counterfeiting verification of the invention, the entering and calling unit further comprises:

An entering module: for entering the merchandise information by the official merchant;

A verifying and recording module: for generating a verification code by virtue of calling the official verification interface, recording the entered merchandise in the database to be authentic and recording the verification code;

An authentication identification adding module: for adding an authentication identification to the entered merchandise.

According to the device for implementing the method for online merchandise anti-counterfeiting verification of the invention, the calling and verifying unit further comprises:

A calling and judging module: for judging whether the brand merchandise is authentic by virtue of calling a brand manufacturer verification interface, if so, adding an authentication identification to the brand merchandise, otherwise undergoing a fake merchandise handling process;

A fake handling module: for confirming the brand merchandise as a fake merchandise, and undergoing a fake merchandise handling process.

According to the device for implementing the method for online merchandise anti-counterfeiting verification of the invention, wherein the calling and storing unit further comprises:

An information acquisition module: for acquiring the production information of the merchandise by virtue of calling the brand manufacturer verification interface;

A storing module: for storing the production information of the merchandise in the database;

A comparing module: for comparing the information of the entered brand merchandise with the production information of the merchandise saved in the database, judging whether the entered information is matched with the saved production information, if so, adding an authentication identification to the brand merchandise, otherwise, confirming the brand merchandise as a fake merchandise, and undergoing a fake merchandise handling process.

According to the device for implementing the method for online merchandise anti-counterfeiting verification of the invention, the brand manufacturer verification interface acquires the production information of the merchandise from the merchandise generating system of the brand manufacturer.

The method and the device thereof for online merchandise anti-counterfeiting verification of the invention have the following beneficial effects: when a merchant applies for opening a store, the entered merchandise is verified for authentication via an official verification interface if the merchant meets official qualification; if the merchant fails to meet the official qualification, through compatibility with the conventional scraping anti-counterfeiting verification of the product, it offers the user with plural times of anti-counterfeiting query and ensures no “fake verification” appeared in the plural times of anti-counterfeiting query; in addition, the merchandise production information of the manufacturer is acquired and saved in the database, and is compared with the entered merchandise information by the merchant to verify whether the merchandise is authentic; therefore, the number of query times for anti-counterfeiting is not limited, and the anti-counterfeiting query supports plural operations.

### BRIEF DESCRIPTION OF THE DRAWINGS

In order to clearly illustrate the technical schemes of the embodiments of the invention, the drawings of the embodiments will be briefly described in the following; it is obvious that the described drawings are only related to some embodiments of the invention; for those skilled in the art, on the precondition of not making creative efforts, other attached drawings can be obtained based on the attached drawings below.

FIG. 1 is a flow chart of the method in one embodiment of the method and the device thereof for online merchandise anti-counterfeiting verification;

FIG. 2 is a specific flow chart of entering the merchandise information of official manufacturer and verifying whether the entered merchandise is authentic by virtue of calling the official verification interface according to the embodiment;

FIG. 3 is a specific flow chart of directly verifying the brand merchandise by virtue of calling the brand manufacturer verification interface according to the embodiment;

FIG. 4 is a specific flow chart of storing the production information of the brand merchandise acquired through the brand manufacturer verification interface and comparing the production information with the entered merchandise information for verification according to the embodiment;

FIG. 5 is a structural schematic diagram of the device according to the embodiment.

### DESCRIPTION OF THE PREFERRED EMBODIMENTS

In order to make clear the objects, technical details and advantages of the embodiments of the invention, the technical schemes of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiments, without any inventive efforts, which should be within the protection scope of the invention.

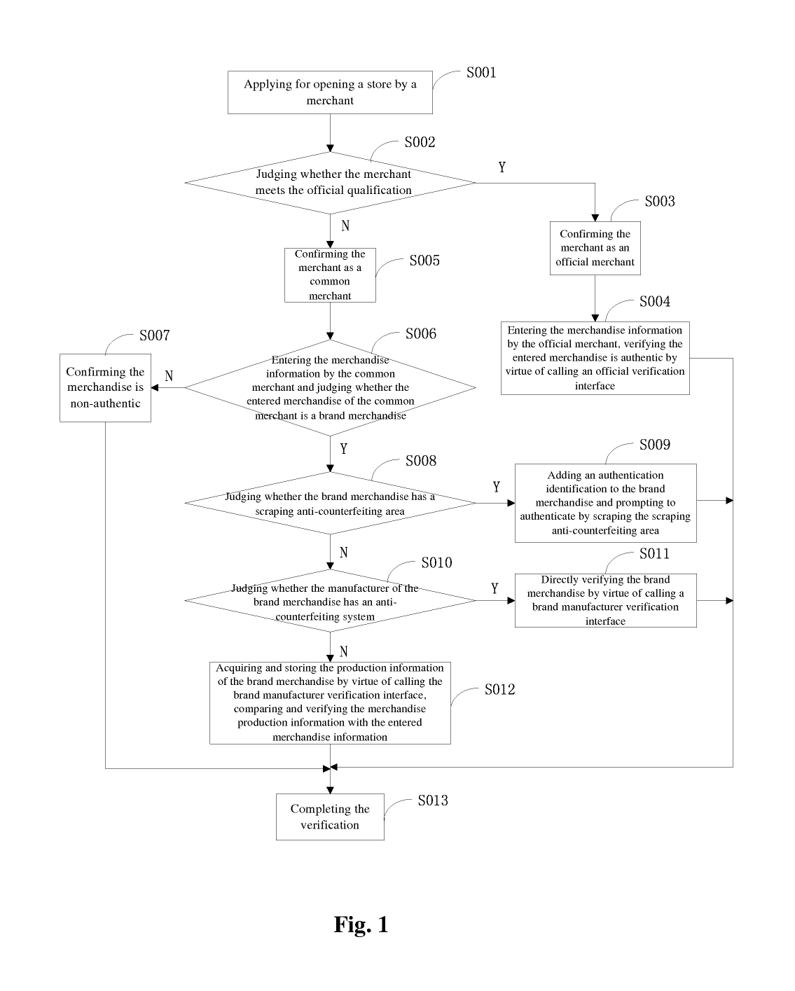

According to the embodiment of the method and the device thereof for online merchandise anti-counterfeiting verification of the invention, the flow chart of the method for online merchandise anti-counterfeiting verification is shown as FIG. 1. In FIG. 1, the method for online merchandise anti-counterfeiting verification comprises the following steps:

Step S001: applying for opening a store by a merchant: in this step: the merchant applies for opening a store.

Step S002: judging whether the merchant meets the official qualification: in this step, it judges whether the merchant meets the official qualification, if so, executes step S003, otherwise, executes step S005.

Step S003: confirming the merchant as an official merchant: if the judgment result of the step S002 is positive, executes this step. In this step, the merchant applying for opening a store is confirmed as an official merchant. After this step, executes step S004.

Step S004: entering the merchandise information by the official merchant and verifying the entered merchandise is authentic by virtue of calling an official verification interface: in this step: the official merchant enters the merchandise information and it verifies the entered merchandise is authentic by virtue of calling an official verification interface. After this step, executing step S013.

Step S005: confirming the merchant as a common merchant: if the judgment result of the step S002 is negative, executes this step. In this step, the merchant applying for opening a store is confirmed as a common merchant. After this step, executes step S006.

Step S006: entering the merchandise information of the common merchant and judging whether the entered merchandise of the common merchant is a brand merchandise: in this step, the common merchant enters the merchandise information and it judges whether the entered merchandise of the common merchant is a brand merchandise; if the judgment result is positive, executes step S008; otherwise, executes step S007.

Step S007: confirming the merchandise is non-authentic: if the judgment result of the step S006 is negative, executes this step. In this step, the merchandise is confirmed to be non-authentic. After this step, executes step S013.

Step S008: judging whether the brand merchandise has a scraping anti-counterfeiting area: in this step, it judges whether the brand merchandise has a scraping anti-counterfeiting area; if the judgment result is positive, executes step S009; otherwise, executes step S010.

Step S009: adding an authentication identification to the brand merchandise and prompting to authenticate the merchandise by scraping the scraping anti-counterfeiting area: if the judgment result of the step S008 is positive, executes this step. In this step, it adds an authentication identification to the brand merchandise and prompts to authenticate the merchandise by scraping the scraping anti-counterfeiting area. After this step, executes step S013.

Step S010: judging whether the manufacturer of the brand merchandise has an anti-counterfeiting system: if the judgment result of the step S008 is negative, executes this step. In this step, it judges whether the manufacturer of the brand merchandise has an anti-counterfeiting system; if the judgment result is positive, executes step S011, otherwise, executes step S012.

Step S011: directly verifying the brand merchandise by virtue of calling a brand manufacturer verification interface: if the judgment result of the step S010 is positive, executes this step. In this step, it directly verifies the brand merchandise by virtue of calling a brand manufacturer verification interface. After this step, executes step S013.

Step S012: acquiring and storing the production information of the brand merchandise by virtue of calling the brand manufacturer verification interface, comparing and verifying the merchandise production information with the entered merchandise information: if the judgment result of the step S010 is negative, executes this step. In this step, it acquires and stores the production information of the brand merchandise by virtue of calling the brand manufacturer verification interface, compares and verifies the merchandise production information with the entered merchandise information. After this step, executes step S013.

Step S013: completing the verification: in this step, completing the merchandise anti-counterfeiting verification. According to the embodiment, the anti-counterfeiting verification interface provided for the merchant mainly includes an official verification interface and a manufacturer verification interface. When the merchant applies for opening a store, the official qualification of the merchant is audited; if the merchant meets the official qualification, it gives the tacit consent to open the official verification interface, and the entered merchandise information of the official manufacturer can be verified to be authentic by virtue of calling the official verification interface. The manufacturer verification interface includes two modes: one mode is compatible with the conventional scraping anti-counterfeiting verification of the merchandise, and directly makes use of the anti-counterfeiting system of the manufacturer or the mall indirectly uses the manufacturer scraping verification interface, and the information returned by the manufacturer scraping verification interface and the user information are stored in the system of the mall, so as to provide the plural times of anti-counterfeiting query to the user; since the identity information and the verification information of the user are saved, the fake verification can be avoided through the plural times of query; the other mode is that the mall is jointed to the manufacturer verification interface, and the mall can verify whether the entered merchandise is authentic by acquiring and storing the merchandise production information of the manufacturer in the database and comparing the merchandise production information with the merchandise production information stored in the database when the merchant enters the merchandise information. Therefore, through the invention, the merchandise purchased online is provided with a function of verifying whether it is authentic as the online searching conducted in the mall, and is simultaneously compatible with conventional online anti-counterfeiting verification function. If failing to confirm whether the merchandise is authentic due to carelessness or slow internet speed, the user can query the merchandise for plural times, thus offering a better experiencing to the user.

According to the embodiment, step S004 can be further detailed, and the detailed flow chart is as shown in FIG. 2. and in FIG. 2, step S004 further comprises:

Step S41: entering the merchandise information by the official merchant: in this step, the official merchant enters merchandise information.

Step S42: generating a verification code by virtue of calling the official verification interface, recording the entered merchandise in the database to be authentic and recording the verification code: in this step, it generates a verification code by virtue of calling the official verification interface, records the entered merchandise in the database to be authentic and the verification code.

Step S43: adding an authentication identification to the entered merchandise: in this step, it adds an authentication identification to the entered merchandise. After this step, executes step S013.

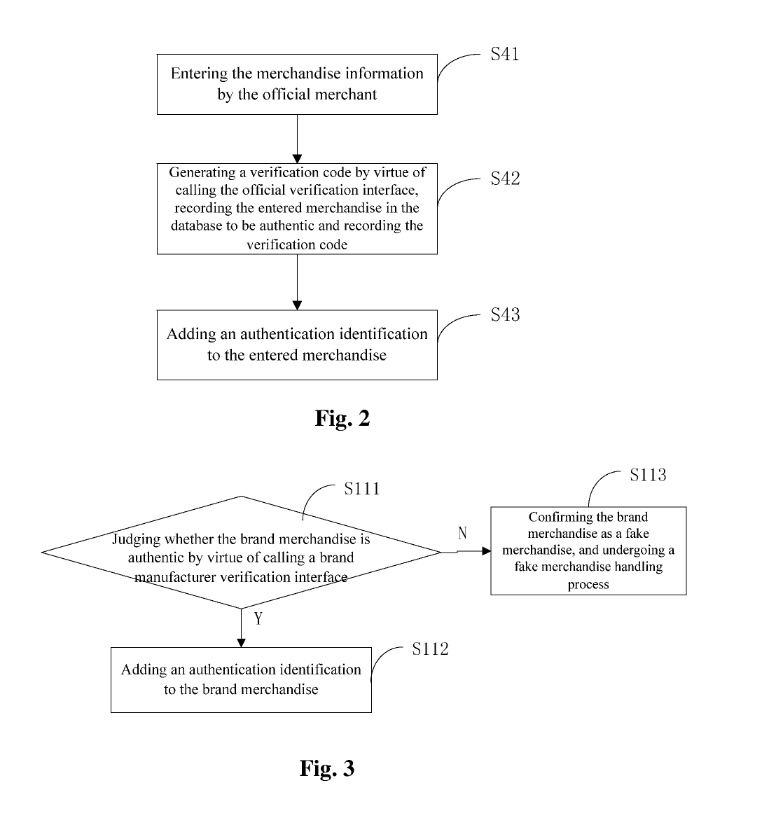

According to the embodiment, step S011 can be further refined, and the refined flow chart is as shown in FIG. 3. And in FIG. 3, step S011 further comprises:

Step S111: judging whether the brand merchandise is authentic by virtue of calling a brand manufacturer verification interface: in this step, it judges whether the brand merchandise is authentic by virtue of calling a brand manufacturer verification interface, if so, executes step S112, otherwise, executes step S113.

Step S112: adding an authentication identification to the brand merchandise: if the judgment result of the step S111 is positive, executes this step. In this step, it adds authentication identification to the brand merchandise. After this step, executes step S013.

Step S113: confirming the brand merchandise as a fake merchandise, and undergoing a fake merchandise handling process: if the judgment result of the step S111 is negative, executes this step. In this step, it confirms the brand merchandise as a fake merchandise, and undergoes a fake merchandise handling process. Herein, the fake merchandise handling process is as same as the conventional fake merchandise handling process. After this step, executes step S013.

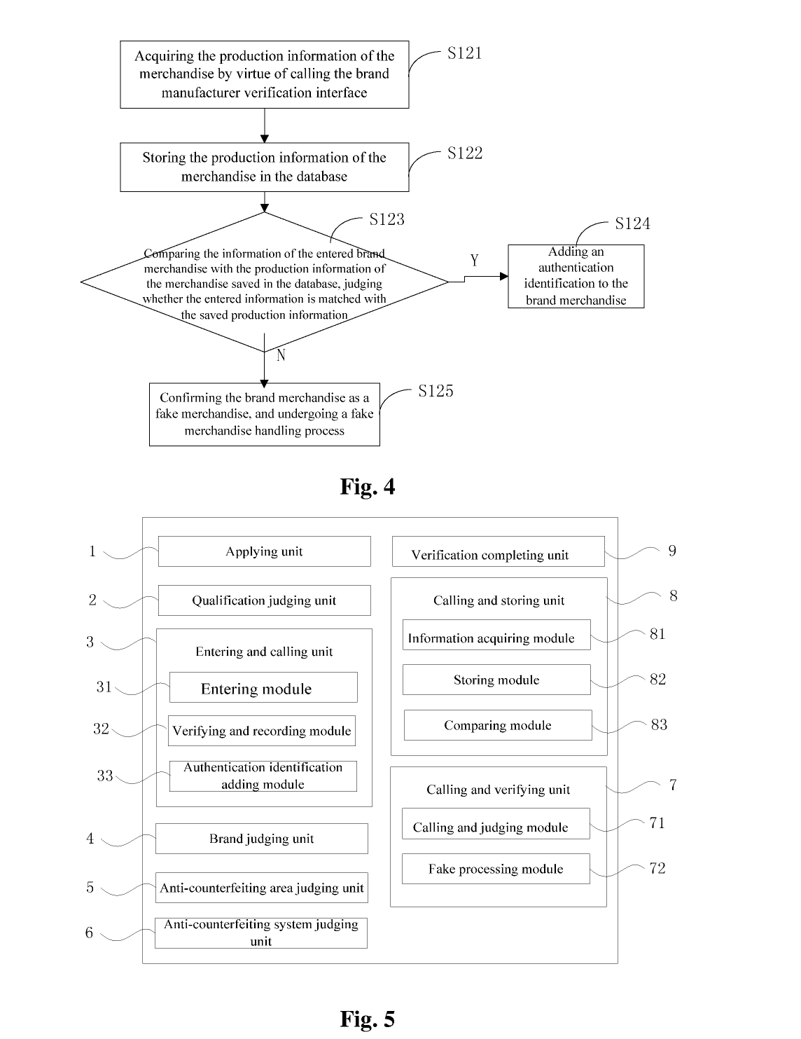

According to the embodiment, step S012 can be further detailed, and the detailed flow chart is as shown in FIG. 4. And in FIG. 4, step S012 further comprises:

Step S121: acquiring the production information of the merchandise by virtue of calling the brand manufacturer verification interface: in this step, it acquires the production information of the merchandise by virtue of calling the brand manufacturer verification interface; the brand manufacturer verification interface acquires the production information of the merchandise from the brand manufacturer merchandise generating system.

Step S122: storing the production information of the merchandise in the database: in this step, it stores the production information of the merchandise in the database for entry and comparison.

Step S123: comparing the information of the entered brand merchandise with the production information of the merchandise saved in the database, judging whether the entered information is matched with the saved production information: in this step, it compares the information of the entered brand merchandise with the production information of the merchandise saved in the database, and judges whether the entered information is matched with the saved production information, if so, executes step S124, otherwise, executes step S125.

Step S124: adding an authentication identification to the brand merchandise: executes this step if the judgment result of the step S123 is positive. In this step, it adds authentication identification to the brand merchandise. After this step, executes S013.

Step S125: confirming the brand merchandise as a fake merchandise, and undergoing a fake merchandise handling process: executes this step if the judgment result of the step S123 is negative. In this step, it confirms the brand merchandise as a fake merchandise, and undergoes a fake merchandise handling process. After this step, executing S013. The production information of the merchandise is stored in the database, so that the user can query whether the merchandise is authentic for plural times.

The embodiment relates to a device for implementing the method for online merchandise anti-counterfeiting verification, and the structural schematic diagram is as shown in FIG. 5. And in FIG. 5, the device for implementing the method for online merchandise anti-counterfeiting verification comprises an applying unit 1, a qualification judging unit 2, an entering and calling unit 3, a brand judging unit 4, an anti-counterfeiting area judging unit 5, an anti-counterfeiting system judging unit 6, a calling and verifying unit 7, a calling and storing unit 8 and a verification completing unit 9, wherein the applying unit 1 is used for applying for opening a store by a merchant; the qualification judging unit 2 is used for judging whether the merchant meets the official qualification, if so, confirming the merchant as an official merchant, otherwise, confirming the merchant as a common merchant; the entering and calling unit 3 is used for entering the merchandise information by the official merchant, verifying the entered merchandise is authentic by virtue of calling an official verification interface; the brand judging unit 4 is used for entering the merchandise information by the common merchant and judging whether the entered merchandise of the common merchant is a brand merchandise, if so, further judging whether the brand merchandise has a scraping anti-counterfeiting area, otherwise, confirming the merchandise is non-authentic; the anti-counterfeiting area judging unit 5 is used for judging whether the brand merchandise has a scraping anti-counterfeiting area, if so, adding an authentication identification to the brand merchandise and prompting to authenticate the merchandise by scraping the scraping anti-counterfeiting area; the anti-counterfeiting system judging unit 6 is used for judging whether the manufacturer of the brand merchandise has an anti-counterfeiting system; the calling and verifying unit 7 is used for directly verifying the brand merchandise by virtue of calling a brand manufacturer verification interface; the calling and storing unit 8 is used for acquiring and storing the production information of the brand merchandise by virtue of calling the brand manufacturer verification interface, comparing and verifying the merchandise production information with the entered merchandise information; the verification completing unit 9 is used for completing the verification. According to the embodiment, the anti-counterfeiting interface provided for the merchant mainly includes an official verification interface and a manufacturer verification interface. When the merchant applies for opening a store, the official qualification of the merchant is audited; if the merchant meets the official qualification, it gives the tacit consent to open the official verification interface, and the entered merchandise information of the official manufacturer can be verified to be authentic by virtue of calling the official verification interface. The manufacturer verification interface includes two modes: one mode is compatible with the conventional scraping anti-counterfeiting verification of the merchandise, directly makes use of the anti-counterfeiting system of the manufacturer or the mall indirectly uses the manufacturer scraping verification interface, and the information returned by the manufacturer scraping verification interface and the user information are stored in the system of the mall, so as to provide the user with plural times of anti-counterfeiting query; since the identity information and the verification information of the user are saved, the fake verification can be avoided through the plural times of query; the other mode is that the mall is jointed to the manufacturer verification interface, and the mall can verify whether the entered merchandise is authentic by acquiring and storing merchandise production information of the manufacturer in the database and comparing the entered merchandise production information with merchandise production information stored in the data when the merchant enters the merchandise information. Therefore, through the invention, the merchandise purchased online is provided with a function of verifying whether it is authentic as the online searching conducted in the mall, and is simultaneously compatible with conventional online anti-counterfeiting verification function. If failing to confirm whether the merchandise is authentic due to carelessness or slow internet speed, the user can query the merchandise for plural times, thus offering a better experiencing to the user.

According to the embodiment, the entering and calling unit 3 further comprises an entering module 31, a verifying and recording module 32 and an authentication identification adding module 33, wherein the entering module 31 is used for entering the merchandise information by the official merchant; the verifying and recording module 32 is used for generating a verification code by virtue of calling the official verification interface, recording the entered merchandise in the database to be authentic and recording the verification code; the authentication identification adding module 33 is used for adding an authentication identification to the entered merchandise. The calling and verifying unit 7 further comprises a calling and judging module 71 and a fake processing module 72, wherein the calling and judging module 71 is used for judging whether the brand merchandise is authentic by virtue of calling a brand manufacturer verification interface, if so, adding an authentication identification to the brand merchandise, otherwise undergoing a fake merchandise handling process; the fake processing module 72 is used for confirming the brand merchandise as a fake merchandise, and undergoing a fake merchandise handling process. The calling and storing unit 8 further comprises an information acquisition module 81, a storing module 82 and a comparing module 83, wherein the information acquisition module 81 is used for acquiring the production information of the merchandise by virtue of calling the brand manufacturer verification interface; the storing module 82 is used for storing the production information of the merchandise in the database; the comparing module 83 is used for comparing the information of the entered brand merchandise with the production information of the merchandise saved in the database, judging whether the entered information is matched with the saved production information, if so, adding an authentication identification to the brand merchandise, otherwise, confirming the brand merchandise as a fake merchandise, and undergoing a fake merchandise handling process.

In conclusion, according to the embodiment, the method and the device thereof have an online searching function as what is conducted in the mall to verify whether the merchandise purchased online is authentic, to query whether the merchandise is authentic for plural times; meanwhile, the conventional online verification is integrated with.

The foregoing embodiments are merely exemplary embodiments of the invention, and not intended to define the scope of the invention, and any modification, equivalent replacement, improvement and the like within the spirits and the principles of the invention shall be included within the protection scope of the invention.

What is claimed is:

1. A method for online merchandise anti-counterfeiting verification, wherein, the method comprises the following steps:
A) Applying for opening a store by a merchant;
B) Judging whether the merchant meets the official qualification, if so, confirming the merchant as an official merchant and executing step C), otherwise, confirming the merchant as a common merchant and executing step D);
C) Entering the merchandise information by the official merchant, verifying the entered merchandise is authentic by virtue of calling an official verification interface and executing step I);
D) Entering the merchandise information of the common merchant and judging whether the entered merchandise by the common merchant is a brand merchandise, if so, executing step E); otherwise, confirming the merchandise is non-authentic and executing step I);
E) Judging whether the brand merchandise has a scraping anti-counterfeiting area, if so, adding an authentication identification to the brand merchandise and prompting to authenticate the merchandise by scraping the scraping anti-counterfeiting area, and executing step I); otherwise, executing step F);
F) Judging whether the manufacturer of the brand merchandise has an anti-counterfeiting system, if so, executing step G); otherwise, executing step H);
G) Directly verifying the brand merchandise by virtue of calling a brand manufacturer verification interface, and executing step I);
H) Acquiring and storing the production information of the brand merchandise by virtue of calling the brand manufacturer verification interface, comparing and verifying the merchandise production information with the entered merchandise information, and executing step I);
I) Completing the verification.

2. The method for online merchandise anti-counterfeiting verification according to claim 1, wherein, the step C) further comprises:
C1) Entering the merchandise information by the official merchant;
C2) Generating a verification code by virtue of calling the official verification interface, recording the entered merchandise in the database to be authentic and recording the verification code;
C3) Adding an authentication identification to the entered merchandise.

3. The method for online merchandise anti-counterfeiting verification according to claim 2, wherein, the step G) further comprises:
G1) Judging whether the brand merchandise is authentic by virtue of calling a brand manufacturer verification interface, if so, adding an authentication identification to the brand merchandise, otherwise, executing step G2);
G2) Confirming the brand merchandise as a fake merchandise, and undergoing a fake merchandise handling process.

4. The method for online merchandise anti-counterfeiting verification according to claims 1, wherein, the step H) further comprises:
H1) Acquiring the production information of the merchandise by virtue of calling the brand manufacturer verification interface;
H2) Storing the production information of the merchandise in the database;
H3) Comparing the information of the entered brand merchandise with the production information of the merchandise saved in the database, judging whether the entered information is matched with the saved production information, if so, adding an authentication identification to the brand merchandise, otherwise, confirming the brand merchandise as a fake merchandise, and undergoing the fake merchandise handling process.

5. The method for online merchandise anti-counterfeiting verification according to claim 2, wherein, the step H) further comprises:
H1) Acquiring the production information of the merchandise by virtue of calling the brand manufacturer verification interface;
H2) Storing the production information of the merchandise in the database;
H3) Comparing the information of the entered brand merchandise with the production information of the merchandise saved in the database, judging whether the entered information is matched with the saved production information, if so, adding an authentication identification to the brand merchandise, otherwise, confirming the brand merchandise as a fake merchandise, and undergoing the fake merchandise handling process.

6. The method for online merchandise anti-counterfeiting verification according to claim 3, wherein, the step H) further comprises:
H1) Acquiring the production information of the merchandise by virtue of calling the brand manufacturer verification interface;
H2) Storing the production information of the merchandise in the database;
H3) Comparing the information of the entered brand merchandise with the production information of the merchandise saved in the database, judging whether the entered information is matched with the saved production information, if so, adding an authentication identification to the brand merchandise, otherwise, confirming the brand merchandise as a fake merchandise, and undergoing the fake merchandise handling process.

7. The method for online merchandise anti-counterfeiting verification according to claim 4, wherein, the brand manufacturer verification interface acquires the production information of the merchandise from the merchandise generating system of the brand manufacturer.

8. A device for implementing the method for online merchandise anti-counterfeiting verification according to claim 1, wherein, the device comprises:
An applying unit: for applying for opening a store by a merchant;
A qualification judging unit: for judging whether the merchant meets the official qualification, if so, confirming the merchant as an official merchant, otherwise, confirming the merchant as a common merchant;
An entering and calling unit: for entering the merchandise information by the official merchant, and verifying the entered merchandise is authentic by virtue of calling an official verification interface;
A brand judging unit: for entering the merchandise information by the common merchant and judging whether the entered merchandise by the common merchant is a brand merchandise, if so, further judging whether the brand merchandise has a scraping anti-counterfeiting area, otherwise, confirming the merchandise is non-authentic;
An anti-counterfeiting area judging unit: for judging whether the brand merchandise has a scraping anti-counterfeiting area, if so, adding an authentication identification to the brand merchandise and prompting to authenticate the merchandise by scraping the scraping anti-counterfeiting area;
An anti-counterfeiting system judging unit: for judging whether the manufacturer of the brand merchandise has an anti-counterfeiting system;
A calling and verifying unit: for directly verifying the brand merchandise by virtue of calling the brand manufacturer verification interface;
A calling and storing unit: for acquiring and storing the production information of the brand merchandise by virtue of calling the brand manufacturer verification interface, comparing and verifying the merchandise production information with the entered merchandise information;
A verification completing unit: for completing the verification.

9. The device for implementing the method for online merchandise anti-counterfeiting verification according to claim 8, wherein, the entering and calling unit further comprises:
An entering module: for entering the merchandise information by the official merchant;
A verifying and recording module: for generating a verification code by virtue of calling the official verification interface, recording the entered merchandise in the database to be authentic and recording the verification code;
An authentication identification adding module: for adding an authentication identification to the entered merchandise.

10. The device for implementing the method for online merchandise anti-counterfeiting verification according to claim 9, wherein, the calling and verifying unit further comprises:
A calling and judging module: for judging whether the brand merchandise is authentic by virtue of calling a brand manufacturer verification interface, if so, adding an authentication identification to the brand merchandise, otherwise undergoing a fake merchandise handling process;
A fake handling module: for confirming the brand merchandise as a fake merchandise, and undergoing a fake merchandise handling process.

11. The device for implementing the method for online merchandise anti-counterfeiting verification according to claim 8, wherein, the calling and storing unit further comprises:
An information acquisition module: for acquiring the production information of the merchandise by virtue of calling the brand manufacturer verification interface;
A storing module: for storing the production information of the merchandise in the database;
A comparing module: for comparing the information of the entered brand merchandise with the production information of the merchandise stored in the database, judging whether the entered information is matched with the saved production information, if so, adding an authentication identification to the brand merchandise, otherwise, confirming the brand merchandise as a fake merchandise, and undergoing a fake merchandise handling process.

12. The device for implementing the method for online merchandise anti-counterfeiting verification according to claim 9, wherein, the calling and storing unit further comprises:
An information acquisition module: for acquiring the production information of the merchandise by virtue of calling the brand manufacturer verification interface;
A storing module: for storing the production information of the merchandise in the database;
A comparing module: for comparing the information of the entered brand merchandise with the production information of the merchandise stored in the database, judging whether the entered information is matched with the saved production information, if so, adding an authentication identification to the brand merchandise, otherwise, confirming the brand merchandise as a fake merchandise, and undergoing a fake merchandise handling process.

13. The device for implementing the method for online merchandise anti-counterfeiting verification according to claim 10, wherein, the calling and storing unit further comprises:
An information acquisition module: for acquiring the production information of the merchandise by virtue of calling the brand manufacturer verification interface;
A storing module: for storing the production information of the merchandise in the database;
A comparing module: for comparing the information of the entered brand merchandise with the production information of the merchandise stored in the database, judging whether the entered information is matched with the saved production information, if so, adding an authentication identification to the brand merchandise, otherwise, confirming the brand merchandise as a fake merchandise, and undergoing a fake merchandise handling process.

14. The device for implementing the method for online merchandise anti-counterfeiting verification according to claim 11, wherein, the brand manufacturer verification interface acquires the production information of the merchandise from the merchandise generating system of the brand manufacturer.
